(19) United States
(12) Patent Application Publication
(10) Pub. No.: US 2025/0209947 A1
(43) Pub. Date: Jun. 26, 2025

(54) Display Device

(71) Applicant: LG Display Co., Ltd., Seoul (KR)

(72) Inventor: Shinji TAKASUGI, Kanagawa (JP)

(21) Appl. No.: 18/959,092

(22) Filed: Nov. 25, 2024

(30) Foreign Application Priority Data
Dec. 22, 2023 (JP) 2023-216432

(51) Int. Cl. G09G 3/00; G09G 3/32

(52) U.S. Cl. CPC G09G 3/006; G09G 3/32; G09G 2310/027; G09G 2320/0233; G09G 2320/0242; G09G 2320/045; G09G 2330/12

(57) ABSTRACT

A display device includes: a pixel array having a plurality of pixels and a gate line, each of the plurality of pixels including a plurality of subpixels, and the plurality subpixels commonly sharing the gate line; a gate driving unit supplying a gate signal to the plurality of subpixels through the gate line; a data driving unit supplying a data signal to each of the plurality of subpixels through a data line; a controlling unit selecting one subpixel from the plurality of subpixels in one pixel of the plurality of pixels based on a deterioration information of the plurality of subpixels and supplying the data signal from the data driving unit to the one subpixel; and a compensating unit obtaining a property value of the one subpixel.

### CROSS-REFERENCE TO RELATED APPLICATION

The present application claims the benefit and priority to Japan Patent Application No. 2023-216432, filed in Japan on Dec. 22, 2023, which is hereby incorporated by reference in its entirety.

### TECHNICAL FIELD

The present disclosure relates to a display device, and more particularly, to a display device where a time of a sensing operation is reduced without deterioration of accuracy of luminance compensation.

### DISCUSSION OF THE RELATED ART

A display device such as an organic light emitting diode display device periodically performs a sensing operation of a pixel property value for compensating a luminance variation due to deterioration of a pixel.

In Korean Patent Publication No. 10-2018-0130207, a display device sensing a property value of a driving transistor from each of subpixels of a pixel commonly sharing a gate line and a reference line is disclosed.

When the subpixels are commonly connected to the gate line and the reference, the corresponding subpixels are not sensed simultaneously. As a result, a sensing operation for compensating a luminance variation between the subpixels may require a relatively long time.

### SUMMARY

Accordingly, the present disclosure is directed to a display device that substantially obviates one or more of the issues due to limitations and disadvantages of the related art.

Therefore, the inventors of the present disclosure recognized the problems mentioned above and other limitations associated with the related art, and conducted various experiments to implement a display device in which the gate signal is sufficiently supplied to a subpixel.

An objective of the present disclosure is to provide a display device where a time of a sensing operation is reduced without deterioration of accuracy of luminance compensation.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

To achieve these and other aspects of the inventive concepts and in accordance with the purpose of the present disclosure, as embodied and broadly described herein, a display device includes: a pixel array having a plurality of pixels and a gate line, each of the plurality of pixels including a plurality of subpixels, and the plurality subpixels commonly sharing the gate line; a gate driving unit supplying a gate signal to the plurality of subpixels through the gate line; a data driving unit supplying a data signal to each of the plurality of subpixels through a data line; a controlling unit selecting one subpixel from the plurality of subpixels in one pixel of the plurality of pixels based on a deterioration information of the plurality of subpixels and supplying the data signal from the data driving unit to the one subpixel; and a compensating unit obtaining a property value of the one subpixel.

It is to be understood that both the foregoing general description and the following detailed description are explanatory and are intended to provide further explanation of the disclosure as claimed.

### BRIEF DESCRIPTION OF THE DRAWINGS

The accompanying drawings, which may be included to provide a further understanding of the disclosure and are incorporated in and constitute a part of this specification, illustrate embodiments of the disclosure and together with the description serve to explain various principles of the disclosure.

FIG. 1 is a view showing a display device according to a first embodiment of the present disclosure.

FIG. 2 is a view showing a portion for sensing a pixel property of a display device according to a first embodiment of the present disclosure.

FIG. 3 is a view showing a compensating unit of a display device according to a first embodiment of the present disclosure.

FIG. 4 is a view showing a treatment of selecting a subpixel for sensing by a controlling unit of a display device according to a first embodiment of the present disclosure.

FIG. 5 is a view showing a compensating method of a display device according to a first embodiment of the present disclosure.

FIG. 6 is a view showing a treatment of selecting a subpixel for sensing by a controlling unit of a display device according to a second embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Reference will now be made in detail to embodiments of the present disclosure, examples of which can be illustrated in the accompanying drawings. In the following description, when a detailed description of well-known functions or configurations related to this document is determined to unnecessarily cloud a gist of the inventive concept, the detailed description thereof will be omitted. The progression of processing steps and/or operations described is an example; however, the sequence of steps and/or operations is not limited to that set forth herein and can be changed as is known in the art, with the exception of steps and/or operations necessarily occurring in a particular order. Like reference numerals designate like elements throughout. Names of the respective elements used in the following explanations are selected only for convenience of writing the specification and can be thus different from those used in actual products.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments are provided so that this disclosure can be sufficiently thorough and complete to assist those skilled in the art to fully understand the scope of the present disclosure. Further, the present disclosure is only defined by scopes of claims.

The shapes, sizes, ratios, angles, numbers, and the like, which are illustrated in the drawings to describe various example embodiments of the present disclosure are merely given by way of example. Therefore, the present disclosure is not limited to the illustrations in the drawings.

Where the terms “comprise,” “have,” “include” and the like are used, one or more other elements may be added unless the terms, such as “only,” is used. An element described in the singular form is intended to include a plurality of elements, and vice versa, unless the context clearly indicates otherwise. Any implementation described herein as an “example” is not necessarily to be construed as preferred or advantageous over other implementations.

In construing an element, the element is construed as including an error range or tolerance range although there is no explicit description of such an error or tolerance range.

In describing a time relationship, for example, when the temporal order is described as, for example, “after,” “subsequent,” “next,” and “before,” a case which is not continuous may be included unless a more limiting term, such as “just,” “immediate (ly),” or “direct (ly)” is used.

Where positional relationships are described, for example, where the positional relationship between two parts is described using “on,” “over,” “under,” “above,” “below,” “beneath,” “near,” “close to,” or “adjacent to,” “beside,” “next to,” or the like, one or more other parts may be disposed between the two parts unless a more limiting term, such as “immediate (ly),” “direct (ly),” or “close (ly)” is used. For example, when a structure is described as being positioned “on,” “over,” “under,” “above,” “below,” “beneath,” “near,” “close to,” or “adjacent to,” “beside,” or “next to” another structure, this description should be construed as including a case in which the structures contact each other as well as a case in which a third structure is disposed or interposed therebetween. Furthermore, the terms “left,” “right,” “top,” “bottom, “downward,” “upward,” “upper,” “lower,” and the like refer to an arbitrary frame of reference.

In describing elements of the present disclosure, the terms like “first,” “second,” “A,” “B,” “(a),” and “(b)” may be used. These terms may be merely for differentiating one element from another element, and the essence, sequence, order, or number of the corresponding elements should not be limited by these terms. Also, when an element or layer is described as being “connected,” “coupled,” or “adhered” to another element or layer, the element or layer can not only be directly connected, or adhered to that other element or layer, but also be indirectly connected, or adhered to that other another element or layer with one or more intervening elements or layers “disposed” between the elements or layers, unless otherwise specified.

Where an element or layer is referred to as being “on” or “connected to” another element or layer, it should be understood to mean that the element or layer may be directly on or directly connected to the other element or layer, or that intervening elements or layers may be present. Also, where one element is referred to as being disposed “on” or “under” another element, it should be understood to mean that the elements may be so disposed to directly contact each other, or may be so disposed without directly contacting each other.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Features of various embodiments of the present disclosure may be partially or overall coupled to or combined with each other, and may be variously inter-operated with each other and driven technically as those skilled in the art can sufficiently understand. Embodiments of the present disclosure may be carried out independently from each other, or may be carried out together in co-dependent relationship.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood by one of ordinary skill in the art.

Hereinafter, embodiments of the present disclosure will be described in detail with reference to the accompanying drawings. Further, all the components of each display device according to all embodiments of the present disclosure are operatively coupled and configured.

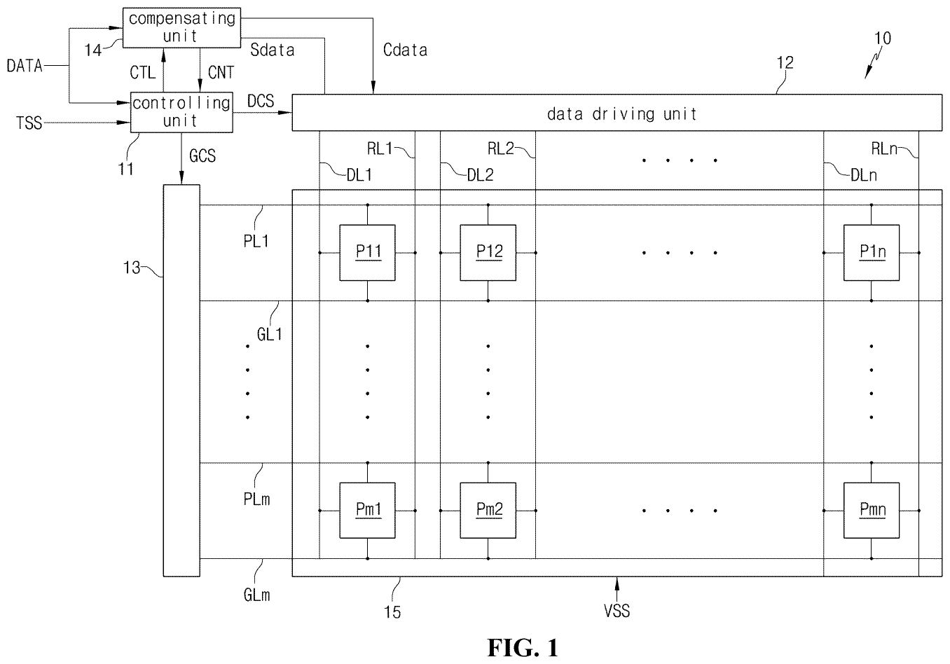

FIG. 1 is a view showing a display device according to a first embodiment of the present disclosure.

In FIG. 1, a display device 10 according to a first embodiment of the present disclosure includes a controlling unit 11, a data driving unit 12, a gate driving unit 13, a compensating unit 14 and a display panel 15. Each of the controlling unit 11, data driving unit 12, gate driving unit 31, and/or compensating unit 14 may be a circuit, and may also be referred to as a controlling circuit, data driving circuit, gate driving circuit, and/or compensating circuit, respectively.

The controlling unit 11(e.g., a circuit) receives a data signal DATA from an image processing unit (not shown). The controlling unit 11 receives a driving signal TSS such as a data enable signal, a vertical synchronization signal, a horizontal synchronization signal and a clock signal. The controlling unit 11 generates a compensation control signal CTL for controlling the compensating unit 14. The controlling unit 11 receives an accumulated data CNT for each pixel from the compensating unit 14. The accumulated data CNT may include a number of the data signal (emission number) inputted to each of a plurality of subpixels in a pixel and data of a luminance value of a light emitted from the subpixel based on the corresponding data signal. The controlling unit 11 estimates a property of each subpixel based on the accumulated data CNT. The controlling unit 11 judges the subpixel having a greatest deterioration among the plurality of subpixels in each pixel using the accumulated data CNT. The controlling unit 11 generates a data control signal DSC for driving the data driving unit 12 and a gate control signal GSC for driving the gate driving unit 13. The controlling unit 11 transmits the data signal DATA and the data control signal DCS to the data driving unit 12. The controlling unit 11 transmits the gate control signal GCS and the compensation control signal CTL to the gate driving unit 13 and the compensating unit 14, respectively.

The data driving unit 12(e.g., a circuit) receives the data signal DATA and the data control signal DCS from the controlling unit 11. The data driving unit 12 converts the data signal DATA to an analog data voltage using the data control signal DCS. The data control signal DCS may include a source stand pulse signal, a source shift clock signal and a source output enable signal. The source stand pulse signal adjusts a start timing of a data sampling of each source driver integrated circuit (not shown) in the data driving unit 12. The source shift clock signal is used for adjusting a timing of a data sampling in each source driver integrated circuit. The source output enable signal adjusts an output timing of a signal from the data driving unit 12.

The data driving unit 12 is electrically connected to a plurality of pixels P11 to Pmn in the display panel 15 through a plurality of data lines DL1 to DLn. The data driving unit 12 supplies the data voltage to the plurality of pixels P11 to Pmn through the plurality of data lines DL1 to DLn. Each of the plurality of data lines DL1 to DLn includes a plurality of signal lines. The plurality of signal lines of each data line are connected to the plurality of subpixels, respectively, of each pixel P11 to Pmn. A conversion period and an output period of the data voltage in the data driving unit 12 may be changed by modulating an output width of the data enable signal and an output width of the source output enable signal. The data driving unit 12 consecutively supplies the data voltage to the plurality of pixels P11 to Pmn through the plurality of data lines DL1 to DLn in synchronization with an output timing of the gate signal. The data voltages supplied to the plurality of pixels P11 to Pmn correspond to luminance of the plurality of pixels P11 to Pmn, respectively. Each data line DL1 to DLn includes a plurality of data lines according to a number of the subpixels in each pixel P11 to Pmn.

The data driving unit 12 is electrically connected to the plurality of pixels P11 to Pmn through a plurality of reference lines RL1 to RLn. The data driving unit 12 supplies a reference voltage to the plurality of pixels P11 to Pmn through the plurality of reference lines RL1 to RLn. Since the data voltage and the reference voltage are supplied to the plurality of pixels P11 to Pmn, the plurality of pixels P11 to Pmn emits a light with an accurate luminance and a property of the plurality of pixels P11 to Pmn is precisely obtained (sensed). The data driving unit 12 obtains a sensing data Sdata of the plurality of subpixels in each pixel P11 to Pmn through the plurality of reference lines RL1 to RLn. The obtainment of the sensing data Sdata will be described below. The data driving unit 12 transmits the sensing data Sdata to the compensating unit 14.

The gate driving unit 13(e.g., a circuit) receives the gate control signal GCS from the controlling unit 11. The gate driving unit 13 is electrically connected to the plurality of pixels P11 to Pmn through a plurality of gate lines GL1 to GLm. The gate driving unit 13 outputs the gate signal to the plurality of gate lines GL1 to GLm based on the gate control signal GCS. The gate signal is transmitted to the plurality of pixels P11 to Pmn through the plurality of gate lines GL1 to GLm.

The gate driving unit 13 may include an inner circuit (not shown) such as a level shifter, a shift register, a delay circuit and a flip-flop. The gate control signal GCS may include a gate start pulse signal, a gate shift clock signal and a gate output enable signal. The gate start pulse signal adjusts a start timing of an operation of a gate driver integrated circuit (not shown) in the gate driving unit 13. The gate shift clock signal as a signal commonly inputted to the gate driver integrated circuit adjusts a shift timing of a scan signal (gate signal). The gate output enable signal designates a timing information of the gate driver integrated circuit. The gate driving unit 13 consecutively generates the gate signal by shifting the gate start pulse signal according to the gate shift clock signal. The gate driving unit 13 supplies the gate signal to the plurality of gate lines GL1 to GLm. The gate signal through the plurality of gate lines GL1 to GLm activates the plurality of pixels P11 to Pmn. The gate driving unit 13 adjusts an output width of the gate signal based on an output width of the data enable signal and the gate output enable signal.

The gate driving unit 13 supplies a high level voltage VDD to the plurality of pixels P11 to Pmn through a plurality of power lines PL1 to PLm. The gate driving unit 13 supplies a low level voltage VSS to the plurality of pixels P11 to Pmn. The plurality of pixels P11 to Pmn receiving the gate signal from the gate driving unit 13 emits a light according to the high level voltage VDD, the low level voltage VSS and the data voltage.

The compensating unit 14 (e.g., a circuit) receives the data signal DATA from the image processing unit. The compensating unit 14 generates the accumulated data CNT based on the data signal DATA. The accumulated data CNT may include information on a sum (counting value) of input values of the data signal DATA to each subpixel. The accumulated data CNT may be a value obtained by adding the data signals supplied to each subpixel based on a predetermined equation. The compensating unit 14 supplies the accumulated data CNT to the controlling unit 11 according to the compensation control signal CTL of the controlling unit 11. The compensating unit 14 receives the sensing data Sdata from the data driving unit 12. The sensing data Sdata may include a current value flowing through the driving transistor DT. The compensating unit 14 generates a compensation data Cdata based on the sensing data Sdata. The compensation data Cdata is a data signal where the non-uniformity of luminance between subpixels is compensated. The compensating unit 14 supplies the compensation data Cdata to the data driving unit 12. The operation of the compensating unit 14 will be described below.

The display panel 15 constitutes a display image of the display device 10. The display panel 15 includes the plurality of pixels P11 to Pmn. The plurality of pixels P11 to Pmn are disposed as a matrix in a plurality of pixel regions defined by crossing of the plurality of gate lines GL1 to GLm extending from the gate driving unit 13 along a horizontal direction and the plurality of data lines DL1 to DLn (m and n are a positive integer) extending from the data driving unit 12 along a vertical direction. Since the plurality of pixels P11 to Pmn are disposed as a matrix, a pixel array is formed in the display panel 15.

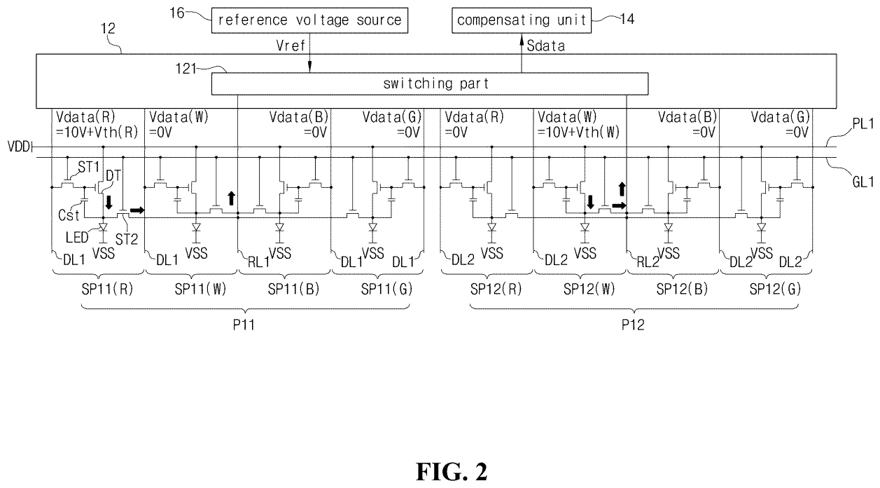

FIG. 2 is a view showing a portion for sensing a pixel property of a display device according to a first embodiment of the present disclosure. FIG. 2 shows a circuit of a first-first pixel P11 and a first-second pixel P12 of the plurality of pixels P11 to Pmn.

In FIG. 2, each of the first-first pixel P11 and the first-second pixel P12 includes four subpixels. The four subpixels may correspond to different colors. The first-first pixel P11 includes a red first-first subpixel SP11(R), a white first-first subpixel SP11(W), a blue first-first subpixel SP11(B) and a green first-first subpixel SP11(G) corresponding to red, white, blue and green colors, respectively. Similarly, the first-second pixel P12 includes a red first-second subpixel SP12(R), a white first-second subpixel SP12(W), a blue first-second subpixel SP12(B) and a green first-second subpixel SP12(G) corresponding to red, white, blue and green colors, respectively. The red first-first subpixel SP11(R), the white first-first subpixel SP11(W), the blue first-first subpixel SP11(B) and the green first-first subpixel SP11(G) of the first-first pixel P11 commonly have (are commonly connected to) a first gate line GL1 and a first reference line RL1. The red first-second subpixel SP12(R), the white first-second subpixel SP12(W), the blue first-second subpixel SP12(B) and the green first-second subpixel SP12(G) of the first-second pixel P12 commonly have (are commonly connected to) the first gate line GL1 and a second reference line RL2. As a result, all first-first subpixels SP11 of the first-first pixel P11 and all first-second subpixels SP12 of the first-second pixel P12 are commonly connected to the first gate line GL1.

Each first-first subpixel SP11 of the first-first pixel P11 includes first and second switching transistors ST1 and ST2, a driving transistor DT, a storage capacitor Cst and a light emitting diode LED. A gate of the first switching transistor ST1 is connected to the first gate line GL1. One of a source and a drain of the first switching transistor ST1 is connected to a first data line DL1. The other of the source and the drain of the first switching transistor ST1 is connected to the gate of the driving transistor DT and one terminal of the storage capacitor Cst. One of a source and a drain of the driving transistor DT is connected to a first power line PL1. The other of the source and the drain of the driving transistor DT is connected to the other terminal of the storage capacitor Cst, one of a source and a drain of the second switching transistor ST2 and an anode of the light emitting diode LED. The other of the source and the drain of the second switching transistor ST2 is connected to the first reference line RL1. The low level voltage VSS is supplied to a cathode of the light emitting diode LED. For example, the light emitting diode LED may be an organic light emitting diode (OLED).

Each first-second subpixel SP12 of the first-second pixel P12 has the same structure as each first-first subpixel SP11 of the first-first pixel P11. In each first-second subpixel SP12, the gate of the first switching transistor ST1 is connected to the first gate line GL1 commonly connected to each first-first subpixel SP11. One of the source and the drain of the first switching transistor ST1 is connected to the first power line PL1 commonly connected to each first-first subpixel SP11. The gate of the second switching transistor ST2 is connected to the first gate line GL1 commonly connected to each first-first subpixel SP11. The other of the source and the drain of the second switching transistor ST2 is connected to the second reference line RL2.

When the gate voltage is supplied to the first gate line GL1, the data voltage Vdata is stored in the storage capacitor Cst through the first and second data lines DL1 and DL2 and the first switching transistor ST1. The data voltage stored in the storage capacitor Cst is supplied between the gate and one of the source and the drain of the driving transistor DT. A current according to the data voltage Vdata, the high level voltage VDD and the low level voltage VSS is supplied to the light emitting diode LED through the driving transistor DT. The light emitting diode LED emits a light having a luminance according to the current. When the gate voltage is supplied to the first gate line GL1, the sensing data Sdata of each subpixel is transmitted to the data driving unit 12 through the second switching transistor ST2, the first reference line RL1 and the second reference line RL2.

For example, the data voltage Vdata of a sum of 10 V and a red threshold voltage Vth (R) (10 V+Vth (R)) is applied to the red first-first subpixel SP11(R) through the first data line DL1, and the data voltage Vdata of a sum of 10 V and a white threshold voltage Vth (W) (10 V+Vth (W)) is supplied to the white first-second subpixel SP12(W) through the second data line DL2. The data voltage Vdata of a black data voltage corresponding to a black color is applied to the other subpixels through the first and second data lines DL1 and DL2. The red threshold voltage Vth (R) is a threshold voltage value of the driving transistor DT of the red first-first subpixel SP11(R), and the white threshold voltage Vth (W) is a threshold voltage value of the driving transistor DT of the white first-second subpixel SP12(W). The black data voltage is a voltage such that the light emitting diode LED does not emit a light. For example, the black data voltage is 0 V.

When the gate voltage equal to or greater than the threshold voltage is supplied to the gate of the first and second switching transistors ST1 and ST2 through the first gate line GL1, a current according to the data voltage Vdata flows through the driving transistors DT of the red first-first subpixel SP11(R) and the white first-second subpixel SP12(W). The current flowing through the driving transistors DT of the red first-first subpixel SP11(R) and the white first-second subpixel SP12(W) is transmitted to the data driving unit 12 through the first and second reference lines RL1 and RL2 as the sensing data Sdata of the red first-first subpixel SP11(R) and the white first-second subpixel SP12(W). When the sensing data Sdata is transmitted, the controlling unit 11 may adjust the light emitting diode LED not to emit a light by changing the low level voltage VSS. Since the black data voltage (e.g., 0 V) is supplied to the gate of the driving transistor DT of the other subpixels except for the red first-first subpixel SP11(R) and the white first-second subpixel SP12(W), a current does not flow through the driving transistor DT. As a result, only the sensing data Sdata of the red first-first subpixel SP11(R) of a portion among the four subpixels of the first-first pixel P11 is obtained through the first reference line RL1. Further, only the sensing data Sdata of the white first-second subpixel SP12(W) of a portion among the four subpixels of the first-second pixel P12 is obtained through the second reference line RL2.

The data driving unit 12 includes a switching part 121. The data driving unit 12 is connected to the first and second reference lines RL1 and RL2 and the compensating unit 14. The data driving unit 12 supplies the reference voltage Vref of a reference voltage source 16 to each subpixel through the switching part 121, the first and second reference lines RL1 and RL2 and the second switching transistor ST2. When the reference voltage Vref is supplied from the reference voltage source 16, the switching part 121 electrically connects the data driving unit 12 and the reference voltage source 16. Before a property of the subpixel is sensed, the data driving unit 12 initializes each subpixel based on the reference voltage Vref. When the property of the subpixel is sensed, the switching part 121 electrically connects the data driving unit 12 and the compensating unit 14. The sensing data Sdata obtained from the subpixel is transmitted to the compensating unit 14 through the data driving unit 12.

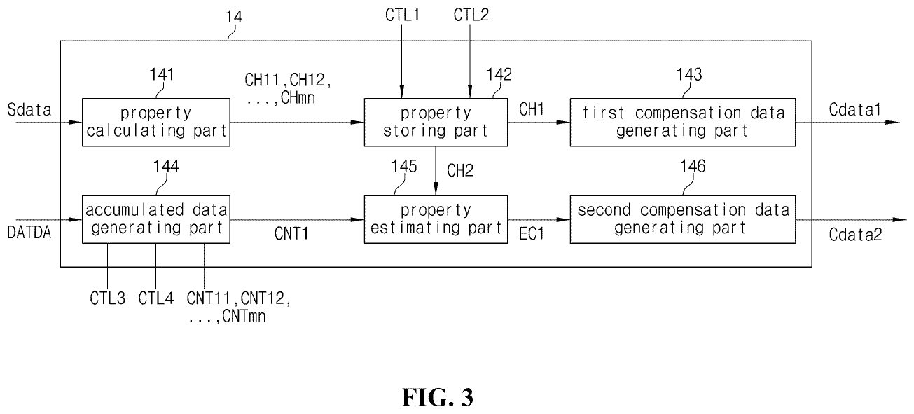

FIG. 3 is a view showing a compensating unit of a display device according to a first embodiment of the present disclosure.

In FIG. 3, the compensating unit 14 includes a property calculating part 141, a property storing part 142, a first compensation data generating part 143, an accumulated data generating part 144, a property estimating part 145 and a second compensation data generating part 146.

The property calculating part 141 receives the sensing data Sdata from the data driving unit 12. The property calculating part 141 calculates a plurality of property values CH11, CH12, . . . , CHmn of the subpixels based on the sensing data Sdata. The first-first property value CH11 corresponds to a portion of subpixels of the first-first pixel P11, the first-second property value CH12 corresponds to a portion of subpixels of the first-second pixel P12, and the mth-nth property value CHmn corresponds to a portion of subpixels of the mth-nth pixel Pmn. For example, the property value may be a threshold voltage of the driving transistor DT of the subpixel where the sensing operation is performed. The first-first property value CH11 may be a threshold voltage of the driving transistor DT of the red first-first subpixel SP11(R), and the first-second property value CH12 may be a threshold voltage of the driving transistor DT of the white first-second subpixel SP12(W).

The property storing part 142 stores the plurality of property values CH11, CH12, . . . , CHmn from the property calculating part 141. The property storing part 142 transmits a first property value CH1 designated among the first-first property value CH11 to the mth-nth property value CHmn according to a first compensation control signal CTL1 to the first compensation data generating part 143. The subpixel corresponding to the first property value CH1 may be a subpixel judged to have the greatest deterioration among the subpixels in the same pixel by the controlling unit 11.

The property storing part 142 transmits a second property value CH2 designated among the first-first property value CH11 to the mth-nth property value CHmn according to a second compensation control signal CTL2 to the property estimating part 145. The subpixel corresponding to the second property value CH2 may be different from the subpixel corresponding to the first compensation control signal CTL1. A color of a light emitted from the subpixel corresponding to the second property value CH2 is different from a color of a light emitted from the subpixel corresponding to the first property value CH1. The second property value CH2 may be a plurality of property values obtained from the plurality of pixels.

The first compensation data generating part 143 receives the first property value CH1 from the property storing part 142. The first compensation data generating part 143 generates a first compensation data Cdata1 based on the first property value CH1. The first compensation data generating part 143 detects a variation amount of the threshold voltage of the driving transistor DT from the first property value CH1 and compensates the variation amount. The first compensation data Cdata1 may be a modified data signal based on the first property value CH1. The first compensation data generating part 143 transmits the first compensation data Cdata1 to the data driving unit 12.

The accumulated data generating part 144 receives the data signal DATA from the image processing unit. The accumulated data generating part 144 generates the accumulated data based on the data signal DATA. The accumulated data generating part 144 measures a counting value of each subpixel based on the data signal DATA and stores the counting value as a first-first accumulated data CNT11, a first-second accumulated data CNT12, . . . , an mth-nth accumulated data CNTmn. The first-first accumulated data CNT11 is an accumulated data of the first-first pixel P11, the first-second accumulated data CNT12 is an accumulated data of the first-second pixel P12, and the mth-nth accumulated data CNTmn is an accumulated data of the mth-nth pixel Pmn. The first-first, first-second, . . . , mth-nth accumulated data CNT11, CNT12, . . . , CNTmn may correspond to deterioration information for each subpixel.

The accumulated data generating part 144 transmits the first-first, first-second, . . . , mth-nth accumulated data CNT11, CNT12, . . . , CNTmn to the controlling unit 11 according to a third compensation control signal CTL3. The controlling unit 11 estimates a property value variation (e.g., the variation of the threshold voltage of the driving transistor) of each subpixel based on the first-first, first-second, . . . , mth-nth accumulated data CNT11, CNT12, . . . , CNTmn received from the accumulated data generating part 144 and specifies the subpixel estimated to have the greatest deterioration. The accumulated data generating part 144 transmits a first accumulated data CNT1 designated among the first-first, first-second, . . . , mth-nth accumulated data CNT11, CNT12, . . . , CNTmn according to a fourth compensation control signal CTL4 of the controlling unit 11 to the property estimating part 145. The first accumulated data CNT1 may include counting values of the plurality of subpixels of one pixel. The accumulated data generating part 144 may extract a luminance value of a light emitted from each subpixel from the data signal DATA. The first-first, first-second, . . . , mth-nth accumulated data CNT11, CNT12, . . . , CNTmn generated by the accumulated data generating part 144 may include an extracted luminance value information. The luminance value information may correspond to a deterioration information.

The property estimating part 145 receives the second property value CH2 designated according to the second compensation control signal CTL2 from the property storing part 142. The property estimating part 145 receives the first accumulated data CNT1 designated according to the fourth compensation control signal CTL4 from the accumulated data generating part 144. The property estimating part 145 estimates the property value of the subpixel based on the second property value CH2 and the first accumulated data CNT1.

The property estimating part 145 estimates a property value variation of the subpixel based on the first accumulated data CNT1. The pixel corresponding to the first accumulated data CNT1 is the same as the pixel corresponding to the first property value CH1 transmitted to the first compensation data generating part 143. The subpixel corresponding to the first accumulated data CNT1 is different from the subpixel corresponding to the first property value CH1 transmitted to the first compensation data generating part 143.

The property estimating part 145 modifies the property value variation of the subpixel calculated from the first accumulated data CNT1 based on the second property value CH2 and generates a first estimated property value EC1. The estimated property value EC1 is a variation of the modified property value of the subpixel corresponding to the first accumulated data CNT1. The first estimated property value EC1 may be a modified variation of the threshold voltage of the driving transistor DT of the subpixel corresponding to the first accumulated data CNT1. The pixel corresponding to the second property value CH2 is different from the pixel corresponding to the first accumulated data CNT1. The pixel corresponding to the second accumulated value CH2 is selected from the pixels adjacent to the pixel corresponding to the first accumulated data CNT1. A color of a light emitted from the subpixel corresponding to the second property value CH2 is the same as a color of a light emitted from the subpixel corresponding to the first accumulated data CNT1.

When the first estimated property value EC1 is generated, the property estimating part 145 may apply a weight to the second property value CH2 and the first accumulated data CNT1 according to a distance from the subpixel corresponding to the second property value CH2 to the subpixel corresponding to the first accumulated data CNT1. For example, the property estimating part 145 may assign a greater weight to the second property value CH2 as the distance from the subpixel corresponding to the second property value CH2 to the subpixel corresponding to the first accumulated data CNT1 is shorter. The property estimating part 145 may assign a greater weight to the first accumulated data CNT1 as the distance from the subpixel corresponding to the second property value CH2 to the subpixel corresponding to the first accumulated data CNT1 is longer. The property estimating part 145 may generate the first estimated property value EC1 based on the first accumulated data CNT1 and the second property value CH2 where the weight is assigned.

The property estimating part 145 transmits the first estimated property value EC1 to the second compensation data generating part 146.

The second compensation data generating part 146 receives the first estimated property value EC1 from the property estimating part 145. The second compensation data generating part 146 generates a second compensation data Cdata2 based on the first estimated property value EC1. The second compensation data generating part 146 obtains a variation amount of the threshold voltage of the driving transistor DT from the first estimated property value EC1 and compensates the variation amount. The second compensation data Cdata2 may be a modified data signal based on the first estimated property value EC1. The second compensation data generating part 146 transmits the second compensation data Cdata2 to the data driving unit 12.

The data driving unit 12 supplies the first compensation data Cdata1 and the second compensation data Cdata2 to the corresponding subpixel. The variation of the threshold voltage of the driving transistor DT in each subpixel is compensated due to the first compensation data Cdata1 and the second compensation data Cdata2. As a result, in the display device 10, all of the pixels in the pixel array may emit a light having a uniform luminance without deviation.

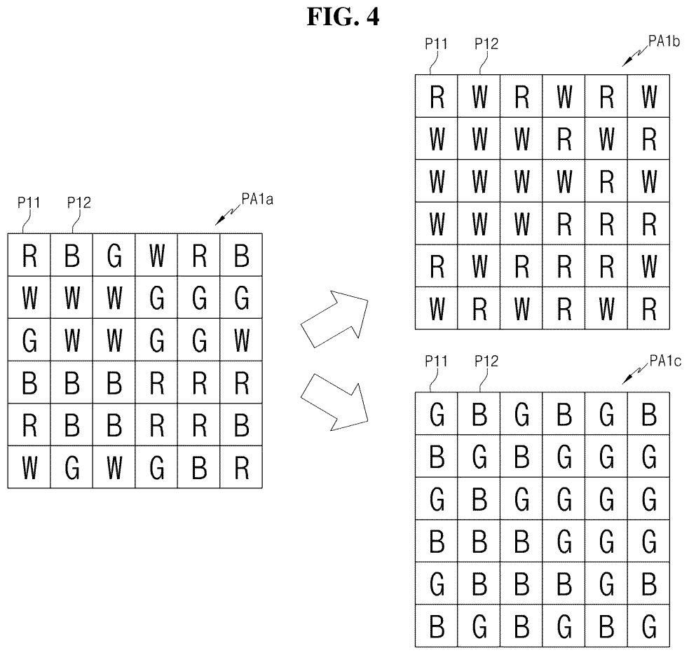

FIG. 4 is a view showing a treatment of selecting a subpixel for sensing by a controlling unit of a display device according to a first embodiment of the present disclosure. Although the treatment for the first-first pixel SP11 and the first-second pixel P12 is illustrated, the treatment may be performed for all pixels P11 to Pmn in the display panel.

In FIG. 4, the controlling unit 11 judges the subpixel having the greatest deterioration among the plurality of subpixels in each pixel based on the first-first, first-second and mth-nth accumulated data CNT11, CNT12, . . . , CNTmn. In a first A pixel area PA1a of 6×6 pixels including the first-first pixel P11 and the first-second pixel P12, colors of the subpixel having the greatest deterioration are marked in each pixel. “R,” “W,” “B” and “G” of FIG. 4 represent the subpixels corresponding to red, white, blue and green colors, respectively. For example, the red first-first subpixel SP11(R) corresponding to the red color has the greatest deterioration in the first-first pixel P11, and the blue first-second subpixel SP12(B) corresponding to the blue color has the greatest deterioration in the first-second pixel P12.

After the subpixels corresponding to the red and white colors are sensed for each pixel, the subpixels corresponding to the blue and green colors are sensed. The sensing operation is performed twice for each pixel, and the sensing data Sdata is obtained from two subpixels in each pixel.

For example, the subpixel corresponding to the red color (first emission color) or the white color (second emission color) is initially sensed. The controlling unit 11 selects the red first-first subpixel SP11(R) judged to have the greatest deterioration in the first-first pixel P11 as a sensing subject. The subpixel having the greatest deterioration in the first-second pixel P12 is the blue first-second subpixel SP12(B) not having the red color or the white color as the emission color. The controlling unit 11 compares deterioration extents of the red first-second subpixel SP12(R) and the white first-second subpixel SP12(W) of the first-second pixel P12 based on the first-second accumulated data CNT12. The controlling unit 11 judges that the deterioration extent of the white first-second subpixel SP12(W) is greater than the deterioration extent of the red first-second subpixel SP12(R) and selects the white first-second subpixel SP12(W) as a sensing subject. The controlling unit 11 performs the same treatment for the other pixels and selects the subpixel corresponding to the red color or the white color as a sensing subject for each pixel. In a first B pixel area PA1b, the subpixels selected as a sensing subject by the controlling unit 11 are shown. The first B pixel area PA1b is the same as the first A pixel area PA1a.

Next, the subpixel corresponding to the blue color or the green color is sensed in the same pixel area. The controlling unit 11 selects the blue first-second subpixel SP12(B) judged to have the greatest deterioration in the first-second pixel P12 as a sensing subject. In the first-first pixel P11, the subpixel having the greatest deterioration is the red first-first subpixel SP11(R). The controlling unit 11 compares deterioration extents of the blue first-first subpixel SP11(B) and the green first-first subpixel SP11(G) of the first-first pixel P11 based on the first-first accumulated data CNT11. The controlling unit 11 judges that the deterioration extent of the green first-first subpixel SP11(G) is greater than the deterioration extent of the blue first-first subpixel SP11(B) and selects the green first-first subpixel SP11(G) as a sensing subject. The controlling unit 11 performs the same treatment for the other pixels and selects the subpixel corresponding to blue color or the green color as a sensing subject. In a first C pixel area PA1c, the subpixels selected as a sensing subject by the controlling unit 11 are shown. The first C pixel area PA1c is the same as the first A pixel area PA1a and the first B pixel area PA1b.

In the first-first pixel P11, the property value variation of the subpixel (first subpixel) not selected as a sensing subject is estimated based on the property value obtained through a sensing from the first-first accumulated data CNT11 of the first subpixel and the subpixel having the same emission color as the first subpixel. The controlling unit 11 may select the subpixel (second subpixel) nearest to the first subpixel among the plurality of subpixels having the same emission color as the first subpixel and having the property value obtained through a sensing for estimating the property value variation of the first subpixel. For example, the property value variation of the white first-first subpixel SP11(W) in the first-first pixel P11(first pixel) is estimated by the compensating unit 14 based on the first-first accumulated data CNT11 for the white first-first subpixel SP11(W) and the property value of the white first-second subpixel SP12(W) of the sensed first-second pixel P12. The property value variation of the blue first-first subpixel SP11(B) is estimated by the compensating unit 14 based on the first-first accumulated data CNT11 for the blue first-first subpixel SP11(B) and the property value of the sensed blue first-second subpixel SP12(B). The compensating unit 14 modifies the property value variation of the white first-first subpixel SP11(W) estimated based on the first-first accumulated data CNT11 for the white first-first subpixel SP11(W) using the property value of the white first-second subpixel SP12(W). The compensating unit 14 modifies the property value variation of the blue first-first subpixel SP11(B) estimated based on the first-first accumulated data CNT11 for the blue first-first subpixel SP11(B) using the property value of the blue first-second subpixel SP12(B). The same treatment is performed to the other pixels, and the property value variation of the subpixel not selected as a sensing subject is estimated by the compensating unit 14.

Since the treatment of FIG. 4 is performed on all pixels and all subpixels of each pixel in the display panel 15, the non-uniformity of the luminance is accurately compensated throughout the entire display area and the time of the sensing operation is reduced.

When the subpixel corresponding to one emission color is selected in a predetermined pixel region based on the accumulated data with a ratio over a predetermined value, the controlling unit 11 may change the selection of the subpixel such that the ratio is not over the predetermined value. For example, the subpixel corresponding to a red color (first emission color) is selected as a sensing subject in a predetermined pixel region with a ratio over a predetermined value, the controlling unit 11 may exclude a portion of the subpixels corresponding to the selected red color from the sensing subject. The controlling unit 11 may select the excluded subpixel and the subpixel corresponding to the white color (second emission color) in the same pixel as a sensing subject. When the controlling unit 11 changes the selection of the subpixel as a sensing subject, the controlling unit 11 may select the pixel including two subpixels having a relatively small difference in the deterioration extent as a changing subject.

When the deterioration extents of the two subpixels are the same as each other, the controlling unit 11 may select the subpixel having the greater maximum luminance as a sensing subject. The subpixel having the white color as an emission color has the maximum luminance greater than the maximum luminance of the subpixel having the red color as an emission color. The subpixel having the green color as an emission color has the maximum luminance greater than the maximum luminance of the subpixel having the blue color as an emission color. For example, when the red first-second subpixel SP12(R) and the white first-second subpixel SP12(W) have the same deterioration extent as each other, the controlling unit 11 may select the white first-second subpixel SP12(W) having the greater maximum luminance as a sensing subject. When the blue first-first subpixel SP11(B) and the green first-first subpixel SP11(G) have the same deterioration extent as each other, the controlling unit 11 may select the green first-first subpixel SP11(G) having the greater maximum luminance as a sensing subject.

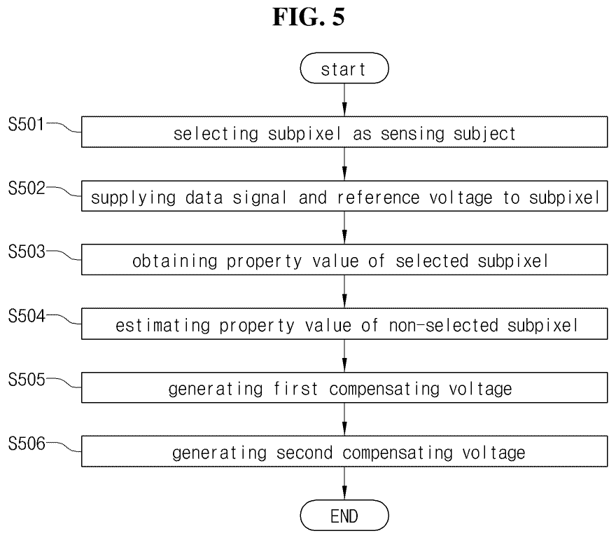

FIG. 5 is a view showing a compensating method of a display device according to a first embodiment of the present disclosure. The treatment for the first-first pixel P11 and the first-second pixel P12 will be described hereinafter.

At a step S501, the controlling unit 11 selects the subpixel for a sensing subject. In a first embodiment of FIGS. 1 to 4, the controlling unit 11 selects the subpixel judged to have a relatively great deterioration extent based on the first-first accumulated data CNT11 and the first-second accumulated data CNT12. In a first embodiment of FIG. 4, the controlling unit 11 selects the red first-first subpixel SP11(R) and the green first-first subpixel SP11(G) for the first-first pixel P11 based on the first-first accumulated data CNT11. The controlling unit 11 selects the white first-second subpixel SP12(W) and the blue first-second subpixel SP12(B) for the first-second pixel P12 based on the first-second accumulated data CNT12.

At a step S502, the controlling unit 11 adjusts the data driving unit 12 and the gate driving unit 13 such that the data signal and the reference voltage Vref is supplied to the selected subpixel. In a first embodiment of FIGS. 1 to 4, the data driving unit 12 supplies the data voltage Vdata to the red first-first subpixel SP11(R), the green first-first subpixel SP11(G), the white first-second subpixel SP12(W) and the blue first-second subpixel SP12(B) selected by the controlling unit 11 through the first and second data lines DL1 and DL2 and the first switching transistor ST1. The data driving unit 12 supplies the black data voltage to the subpixel not selected by the controlling unit 11. In a first embodiment of FIG. 2, the data driving unit 12 supplies the reference voltage Vref to the red first-first subpixel SP11(R), the white first-first subpixel SP11(W), the blue first-first subpixel SP11(B) and the green first-first subpixel SP11(G) in the first-first pixel P11 through the first reference line RL1 and the second switching transistor ST2. The data driving unit 12 supplies the reference voltage Vref to the red first-second subpixel SP12(R), the white first-second subpixel SP12(W), the blue first-second subpixel SP12(B) and the green first-second subpixel SP12(G) in the first-second pixel P12 through the second reference line RL2 and the second switching transistor ST2.

At a step S503, the controlling unit 11 adjusts the data driving unit 12 to obtain the property value of the selected subpixel. In a first embodiment of FIGS. 1 to 4, the first reference line RL1 has a floating state due to the data driving unit 12 and the data driving unit 12 obtains a current flowing through the driving transistor DT of the red first-first subpixel SP11(R), the green first-first subpixel SP11(G), the white first-second subpixel SP12(W) and the blue first-second subpixel SP12(B) as the sensing data Sdata of the selected subpixel. The data driving unit 12 transmits the sensing data Sdata to the compensating unit 14.

As a step S504, the controlling unit 11 adjusts the compensating unit 14 such that the property value of the subpixel not selected as a sensing subject and the first estimated property value EC1 is generated. In a first embodiment of FIGS. 1 to 4, the compensating unit 14 estimates the property value of the white first-first subpixel SP11(W) and the blue first-first subpixel SP11(B) not selected as a sensing subject based on the first-first accumulated data CNT11 and the second property value CH2 for the white first-first subpixel SP11(W) and the blue first-first subpixel SP11(B). The property value estimated by the compensating unit 14 corresponds to the first estimated property value EC1. The first estimated property value EC1 may be a variation amount of the threshold voltage of the driving transistor DT of the white first-first subpixel SP11(W) and the blue first-first subpixel SP11(B). The second property value CH2 may be obtained through a sensing for the subpixel adjacent to the first-first pixel P11. For example, the second property value CH2 may be the threshold voltage of the driving transistor DT obtained through the sensing operation for the white first-second subpixel SP12(W) and the blue first-second subpixel SP12(B). The compensating unit 14 estimates the property value of the red first-second subpixel SP12(R) and the green first-second subpixel SP12(G) not selected as a sensing subject based on the first-second accumulated data CNT12 and the second property value CH2 for the red first-second subpixel SP12(R) and the green first-second subpixel SP12(G). The first estimated property value EC1 may be a variation amount of the threshold voltage of the driving transistor DT of the red first-second subpixel SP12(R) and the green first-second subpixel SP12(G). The second property value CH2 may be obtained through a sensing for the subpixel adjacent to the first-second pixel P12. For example, the second property value CH2 may be the threshold voltage of the driving transistor DT obtained through the sensing operation for the red first-first subpixel SP11(R) and the green first-first subpixel SP11(G).

At a step S505, the controlling unit 11 adjusts the compensating unit 14 to generate the first compensation data Cdata1. In a first embodiment of FIGS. 1 to 4, the compensating unit 14 calculates the first-first property value CH11 and the first-second property value CH12 from the sensing data Sdata obtained at the step S503. The compensating unit 14 supplies the first compensation data Cdata1 as a compensated data signal based on the first-first property value CH11 and the first-second property value CH12 to the data driving unit 12.

At a step S506, the controlling unit 11 adjusts the compensating unit 14 to generate the second compensation data Cdata2. In a first embodiment of FIGS. 1 to 4, the compensating unit 14 supplies the second compensation data Cdata2 as the compensated data signal based on the first estimated property value EC1 generated at the step S504 to the data driving unit 12. The data driving unit 12 supplies the second compensation data Cdata2 to the white first-first subpixel SP11(W), the blue first-first subpixel SP11(B), the red first-second subpixel SP12(R) and the green first-second subpixel SP12(G) not selected as a sensing subject.

The threshold voltage variation of the driving transistor of each pixel due to a long-term use may be estimated from a counting value. The threshold voltage of the driving transistor estimated from the counting value may have a gap from a real threshold voltage obtained through the sensing operation due to a usage condition and a usage environment of the display device. As a result, to compensate the threshold voltage variation of the driving transistor with a relatively high accuracy, it is preferable to obtain the property value of the subpixel by sensing all subpixels in the pixel. It requires a relatively long time to finish the sensing operation for all subpixels. Further, as a resolution of the display device increases, the time for the sensing operation increases. To reduce the time for the sensing operation, it may be considered to sense a portion of the plurality of subpixels in the pixel using a predetermined pattern. However, since deterioration is relatively great, the subpixels where the property is required to be compensated may be different in the pixels. Accordingly, when the subpixel for the sensing operation is selected using the pattern, the subpixel having a relatively high necessity for compensation of the property (subpixel having greatest deterioration) may not be properly sensed.

In the display device 10 according to a first embodiment of the present disclosure, only a portion of the plurality of subpixels in the pixel is sensed. As the subpixel for the sensing operation, the subpixel having the greatest deterioration of the light emitting diode based on the accumulated data including the counting value. Further, the property value estimated from the accumulated data of the subpixel not sensed is modified using the property value obtained by sensing the subpixel having the same emission color and disposed adjacent to the corresponding subpixel. As a result, the display device 10 compensates the non-uniformity of the luminance of the subpixel and reduces the time for the sensing operation.

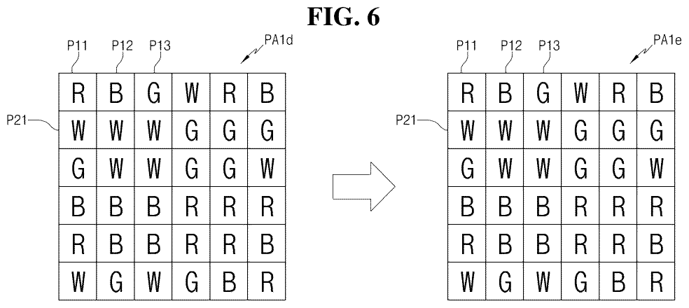

A display device according to a second embodiment of the present disclosure will be described with reference to FIG. 6.

FIG. 6 is a view showing a treatment of selecting a subpixel for sensing by a controlling unit of a display device according to a second embodiment of the present disclosure. Differently from the first embodiment, the sensing operation is performed only once to each pixel in a predetermined pixel region in the second embodiment. Although the treatment for the first-first pixel SP11 and the first-second pixel P12 is illustrated, the treatment may be performed for all pixels P11 to Pmn in the display panel.

In a first D pixel area PA1d of FIG. 6, the subpixel judged to have the greatest deterioration is shown in a pixel region of 6×6 pixels including a first-first pixel P11 and a first-second pixel P12. For example, a red first-first subpixel SP11(R) corresponding to a red color has the greatest deterioration in the first-first pixel P11, and a blue first-second subpixel SP12(B) corresponding to a blue color has the greatest deterioration in the first-second pixel P12.

In the display device according to a second embodiment of the present disclosure, one subpixel is sensed for each pixel. The sensing operation is performed once for each pixel. For example, a controlling unit 11 selects the red first-first subpixel SP11(R) judged to have the greatest deterioration in the first-first pixel P11 as a sensing subject. The controlling unit 11 selects the blue first-second subpixel SP12(B) judged to have the greatest deterioration in the first-second pixel P12 as a sensing subject. The controlling unit 11 performs the same operation for the other pixels and selects the subpixel for each pixel. In a first E pixel area PA1e of FIG. 6, the subpixels selected as a sensing subject by the controlling unit 11 are shown. The first E pixel area PA1e is the same as the first D pixel area PA1d.

In the first-first pixel P11, the property value variation of a white first-first subpixel SP11(W), a blue first-first subpixel SP11(B) and a green first-first subpixel SP11(G) not selected as a sensing subject are estimated by the compensating unit 14 based on a first-first accumulated data CNT11 of each subpixel and a property value of the sensed subpixel in an adjacent pixel. For example, the property value variation of the white first-first subpixel SP11(W) is estimated by the compensating unit 14 based on the first-first accumulated data CNT11 for the white first-first subpixel SP11(W) and the property value of the sensed white second-first subpixel SP21(W). The property value variation of the blue first-first subpixel SP11(B) is estimated by the compensating unit 14 based on the first-first accumulated data CNT11 for the blue first-first subpixel SP11(B) and the property value of the sensed blue first-second subpixel SP12(B). The property value variation of the green first-first subpixel SP11(G) is estimated by the compensating unit 14 based on the first-first accumulated data CNT11 for the green first-first subpixel SP11(G) and the property value of a sensed blue first-third subpixel SP13(G). The compensating unit 14 may estimate the property value variation of the green first-first subpixel SP11(G) based on the property value of the green first-third subpixel SP13(G) and the property value of a green third-first subpixel SP31(G). For example, the compensating unit 14 may estimate the property value variation of the green first-first subpixel SP11(G) based on an average of the property value of the green first-third subpixel SP13(G) and the property value of the green third-first subpixel SP31(G). The same treatment is performed on the other pixels, and the property value of the subpixel not selected is estimated by the compensating unit 14.

Since the above treatment of FIG. 6 is performed to all pixels in a display panel 15, the time of the sensing operation for the entire display area of the display device is further reduced.

When the subpixel corresponding to one emission color is selected in a predetermined pixel region based on the accumulated data with a ratio over a predetermined value, the controlling unit 11 may change the selection of the subpixel such that the ratio is not over the predetermined value. For example, the subpixel corresponding to a red color is selected as a sensing subject in a predetermined pixel region with a ratio over a predetermined value, the controlling unit 11 may exclude a portion of the subpixels corresponding to the selected red color from the sensing subject. The controlling unit 11 may select the subpixel corresponding to one of the white color, the blue color and the green color in the pixel including the excluded subpixel. When the controlling unit 11 changes the selection of the subpixel, the controlling unit 11 may select the subpixel corresponding to the emission color having the smallest number of selection in the predetermined pixel region instead of the subpixel corresponding to the red color.

When the deterioration extents of the two or more subpixels are the same as each other, the controlling unit 11 may select the subpixel having the greatest maximum luminance. For example, for the four emission colors of FIG. 2, the red color has the maximum luminance greater than the maximum luminance greater than the maximum luminance of the blue color. The green color has the maximum luminance greater than the maximum luminance of the red color and the blue color, and the white color has the maximum luminance greater than the maximum luminance of the green color, the red color and the blue color. As a result, when the two or more subpixels have the same deterioration extent as each other, the controlling unit 11 may most preferentially select the subpixel having the white emission color as a sensing subject, may preferentially select the subpixel having the green emission color, and may preferentially select the subpixel having the red emission color.

When the subpixel corresponding to one emission color is not selected in the predetermined pixel region, the controlling unit 11 may change the selection such that the subpixel having the one emission color becomes a sensing subject in the predetermined pixel region. For example, the subpixel having the red color as the emission color is not selected in the predetermined pixel region, the controlling unit 11 may exclude a portion of the subpixels having the selected white color, the blue color and the green color as the emission color. The controlling unit 11 may select the subpixel corresponding to the red color in the pixel including the excluded subpixel. When the controlling unit 11 changes the selection, the controlling unit 11 may exclude the subpixel corresponding to the emission color most selected as the sensing subject in the predetermined pixel region.

The display device according to a second embodiment of the present disclosure may accurately compensate the non-uniformity of the luminance and may reduce the time for the sensing operation.

In the first and second embodiments, the controlling unit 11 is formed as a structure different from the compensating unit 14. In another embodiment, the compensating unit 14 may not be formed as a structure different from the controlling unit 11. For example, the controlling unit 11 may be formed as one chip, and the compensating unit 14 may be integrated in the chip to provide all functions to the controlling unit 11.

Each unit and each operation may be realized by a processor and a memory cooperating with the processor in the first and second embodiments. For example, the processor may operate each unit according to illustration of the first and second embodiments by reading and executing a program stored in the memory. The processor may be included in each unit of the first and second embodiments. The processor may be a central processing unit (CPU) or a micro processor unit (MPU). The memory cooperating with the processor may be a non-volatile memory.

It is to be noted that first and second embodiments of the present disclosure are shown by way of example only, and the present disclosure is not limited thereto. Any one or more elements or features disclosed in the first and second embodiments may be selectively combined to arrive at new embodiments.

It will be apparent to those skilled in the art that various modifications and variation can be made in the present disclosure without departing from the scope of the disclosure. Thus, it is intended that the present disclosure cover the modifications and variations of this disclosure provided they come within the scope of the appended claims.

What is claimed is:

1. A display device, comprising:
a pixel array having a plurality of pixels and a gate line, each of the plurality of pixels including a plurality of subpixels, and the plurality of subpixels commonly sharing the gate line;
a gate driving circuit configured to supply a gate signal to the plurality of subpixels through the gate line;
a data driving circuit configured to supply a data signal to each of the plurality of subpixels through a data line;
a controlling circuit configured to select one subpixel from the plurality of subpixels in one pixel of the plurality of pixels based on a deterioration information of the plurality of subpixels, and supply the data signal from the data driving circuit to the one subpixel; and
a compensating circuit configured to obtain a property value of the one subpixel.

2. The display device of claim 1, wherein the deterioration information is obtained by adding the data signal until a timing when the data signal is supplied to the one subpixel based on a predetermined equation.

3. The display device of claim 2, wherein each of the plurality of pixels includes a first subpixel which is not selected and a second subpixel which is selected, and
wherein the compensating circuit estimates the property value of the first subpixel of the one pixel based on accumulated data of the first subpixel of the one pixel and the property value obtained from the second subpixel of other pixels of the plurality of pixels.

4. The display device of claim 3, wherein the first subpixel of the one pixel has a same emission color as the second subpixel of the other pixels.

5. The display device of claim 4, wherein the compensating circuit estimates the property value of the first subpixel of the one pixel based on the property value of the second subpixel of one other pixel nearest to the first subpixel among the other pixels.

6. The display device of claim 5, wherein the compensating circuit estimates the property value of the first subpixel based on the property value obtained from the second subpixel.

7. The display device of claim 6, wherein the compensating circuit estimates the property value of the first subpixel according to a distance from the first subpixel to the second subpixel.

8. The display device of claim 3, wherein the controlling circuit selects the one subpixel estimated to have a greatest deterioration from the plurality of subpixels based on the accumulated data.

9. The display device of claim 8, wherein the compensating circuit obtains the property value from two subpixels among the plurality of subpixels.

10. The display device of claim 9, wherein the plurality of subpixels have a first emission color and a second emission color, and
wherein when the one subpixel having the greatest deterioration does not have one of the first emission color or the second emission color, the controlling circuit selects a subpixel having a greater deterioration by comparing the accumulated data of a subpixel having the first emission color and the accumulated data of a subpixel having the second emission color.

11. The display device of claim 8, wherein the controlling circuit selects a subpixel estimated to have the greatest deterioration among the plurality of subpixels based on the accumulated data and a maximum luminance of the one subpixel.

12. The display device of claim 11, wherein when two or more subpixels among the plurality of subpixels are judged to have a same deterioration extent as each other based on the accumulated data, the controlling circuit selects a subpixel having the maximum luminance.

13. The display device of claim 8, wherein the plurality of subpixels have a first emission color and a second emission color, and
wherein when a subpixel having the first emission color is selected in a predetermined pixel region with a ratio over a predetermined value, the controlling circuit excludes a portion of the plurality of subpixels having the first emission color and having the greatest deterioration from a selection subject and selects a subpixel having the second emission color.

14. The display device of claim 8, wherein the plurality of subpixels have different emission colors, and
wherein when an emission color is not selected in a predetermined pixel region, the controlling circuit selects a subpixel corresponding to the emission color not selected instead of the subpixel having the greatest deterioration.

15. The display device of claim 3, wherein the compensating circuit generates:
a data voltage where a property value variation of the selected subpixel is compensated based on the property value obtained; and
a data voltage where a property value variation of the first subpixel is compensated based on the estimated property value.

16. The display device of claim 1, wherein when the data driving circuit supplies the data signal to the selected subpixel, the data driving circuit supplies a black data voltage corresponding to a black color to the plurality of subpixels except for the selected subpixel.

17. The display device of claim 1, wherein before the data driving circuit supplies the data signal, the data driving circuit supplies a reference voltage to the plurality of subpixels through a reference line which the plurality of subpixels commonly share, and
wherein the compensating circuit obtains the property value through the reference line.

18. The display device of claim 1, wherein the controlling circuit selects a subpixel from each of the plurality of pixels in the pixel array, and
wherein the compensating circuit obtains the property value from the selected subpixel of each of the plurality of pixels.

19. The display device of claim 1, wherein each of the plurality of subpixels includes a light emitting diode.
